(19) United States
(12) Patent Application Publication
(10) Pub. No.: US 2009/0089380 A1
(43) Pub. Date: Apr. 2, 2009

(54) Aggregating and Delivering Information

(75) Inventors: Qiang Wang, Redmond, WA (US); Jeffrey Brian Kay, Bellevue, WA (US); Min Wei, Bellevue, WA (US); Padmini Chandrasekhar, Redmond, WA (US); Agnita Pandian, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/863,572

(22) Filed: Sep. 28, 2007

(51) Int. Cl. G06F 15/16

(52) U.S. Cl. 709/206

(57) ABSTRACT

Embodiments are provided which include functionality to manage and control a provision of information to end users. In an embodiment, components of a system can be configured to manage and control a delivery of web feed information through an information pipeline. In one embodiment, components of a system can be configured to manage and control a delivery of subscription content and other information associated with a number of subscriptions to user email applications. A framework can be configured to use one or more serving components when managing and controlling the delivery of subscription content to end users. Other embodiments and functionality are available.

### BACKGROUND

Information consumers are constantly looking for ways to quickly and efficiently obtain desirable information. Web feeds can be used to provide information to an information consumer. Aggregation systems can be used to consolidate multiple feeds so that a user does not have to locate each and ever; web feed.

### SUMMARY

This summary is provided to introduce a selection of concepts in a simplified form that are further described below in the Detailed Description. This summary, is not intended to identify key features or essential features of the claimed subject matter, nor is it intended as an aid in determining the scope of the claimed subject matter.

Embodiments are provided which include functionality to manage and control a provision of information to end users. In an embodiment, components of a system can be configured to manage and control a server-side delivery of web feed information through an information pipeline. In one embodiment, components of a system can be configured to manage and control a server-side delivery of subscription content and other information associated with a number of subscriptions to users through an email pipeline using an email framework. The email framework can be configured to use one or more serving components when managing and controlling the delivery of subscription content to end users.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary system configured to provide information.

FIG. 2 is a block diagram of an exemplary system configured to provide information.

FIG. 3 is a flow diagram illustrating, an exemplar), process for providing information.

FIG. 4 depicts an exemplary user interface that can be configured to enable a user to subscribe to various information sources.

FIG. 5 depicts an example user email application.

FIG. 6 depicts an example user email application.

FIG. 7 is a block diagram illustrating a computing environment for implementation of various embodiments described herein.

### DETAILED DESCRIPTION

Embodiments are provided which include functionality to manage and control a provision of information to end users. In an embodiment, components of a system can be configured to manage and control a delivery of web feed information through an information pipeline. In one embodiment, components of a system can be configured to manage and control a delivery of subscription content and other information associated with a number of subscriptions to users through an email pipeline. Moreover, a user, such as an administrator for example, can use features of the system to determine if users are subscribing to potentially damaging content. A user can also use features of the system to prevent others from subscribing to and gathering unauthorized content.

Components of the system can be configured according to an email framework including the associated functionality. The email framework can be configured to use one or more serving components to manage and control the delivery of subscription content to end users. Consequently, users can conveniently use an email client to interact with the delivered information. Components of the system can be used to manage and control the delivery of subscription content to an electronic mail (email) application or client. End users can interact with the subscription content using the email client. For example, a user can use an email client to receive subscription information which can be aggregated and delivered by a server-side aggregation component.

In an embodiment, a system includes aggregation, subscription, and email components which can be configured to aggregate, manage, and control a distribution of information associated with a number of subscriptions, but the system and its components are not so limited. The system can include a number of rules that can be used when managing and controlling the deliver of subscription content and other information associated with one or more user subscriptions to a user's e-mail application.

The number of rules can be used to apply and configure filters, policies, journals, and/or other control features when managing the delivery of information associated with a number of subscriptions and users. The system can also include a number of handlers which can be configured to manage various subscription types. In one embodiment, the handlers can be configured to convert subscription content to an email or some other desired format as part of delivering the subscription content to an end user.

In another embodiment, a system includes one or more serving computing devices which include aggregation, subscription, and email functionality. For example, a serving computing device can include mailbox, aggregation, subscription, and/or other applications which can be configured to aggregate, manage, and deliver information associated with a number of subscriptions to end users who receive the information via an email application. Upon receipt, a user can use the email application to interact with the delivered information. The system can be used to aggregate and control a deliver of web feed content to user email inboxes. For example, the system can be used to aggregate and deliver really simple syndication (RSS) content, wherein RSS can be described as a web feed format that may be used to publish frequently updated content such as blogs, news, pod casts, and other information. An RSS document or file can include a summary of content from an associated source, full text, or links to the content.

In yet another embodiment, a system includes a mail server and a hub server. The mail server includes a subscription application that can be configured to execute a subscription retrieval process. The hub server includes an aggregation application that can be configured to execute a content aggregation process. In one embodiment, the system can operate to aggregate information associated with a number of user subscriptions and then apply certain rules to subscription information being communicated through an email pipeline to user inboxes.

After applying any rules, the subscription information may or may not be delivered to a user's email inbox. In some cases, subscription information can be diverted, rerouted, saved, and/or not delivered. Other operations can be implemented by configuring various rules or adding new rules to control delivery and other information communications. In one embodiment: upon delivery, a user can use a web application, an email application, or other interactive application to interact with the subscription information. As part of the interaction, a user can monitor and control web feed and other subscriber information.

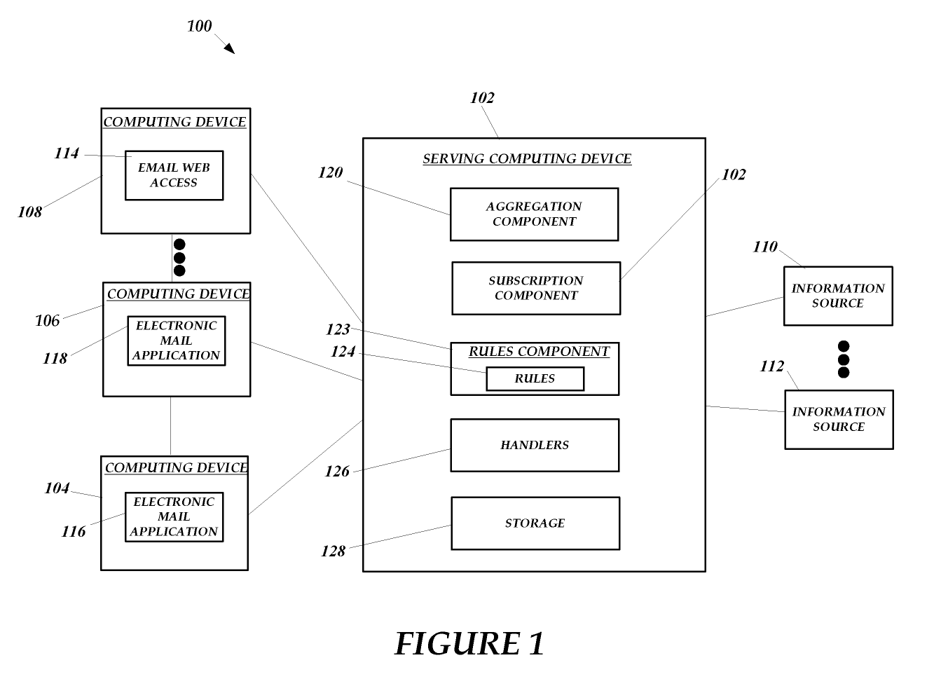

FIG. 1 depicts a system 100 that can be configured to provide information to a user or users of the system 100, in accordance with an embodiment. As described below, in one embodiment, components of the system 100 can be configured to provide a content aggregation framework using an e-mail infrastructure. The email infrastructure can be used to manage and control the delivery of subscription content to end users. For example, components of the system 100 can be configured to provide a content syndication framework using the functionality of an EXCHANGE and EXCHANGE SERVER infrastructure provided by MICROSOFT CORPORATION.

As described below, components of the system 100 can be configured to communicate syndicated content and other information using an email infrastructure and functionality. In various embodiments, routing features, messaging policies, content sanitization, message processing extensibility, security, spanning, antivirus, anywhere access, and/or other features and functionality can be used to provide syndicated and other content to end users of an email, messaging, or other communication system. For example, email processing rules and formats can be used to provide syndicated and other content to end users who have an email account or application. In various embodiments, information from web feeds, alternative email stores, calendars, contacts, and/or other information sources can be aggregated and provided to a user email application. In one embodiment, components of a system can be configured to enable a user to reply, using an email application, to a web feed item, wherein the reply can be communicated to a feed site or feed provider.

In one embodiment, components of the system 100 can be configured to provide information, such as published or syndicated content for example, including updated content, to a user's email account, wherein the system includes a number of rule and handler components. For example, the system 100 can be configured to provide information associated with a web feed to a user's e-mail account, wherein messaging rules can be used to apply and manage policies associated with the information, including delivery options associated therewith. Components of the system 100 can be configured to tailor information associated with a web feed, such as an RSS feed for example, such that the information appears in the context of an email message or other desired format or context. Additionally, components of the system 100 can be configured to apply and use policies, rules, and/or other constraints to all types of feeds and other information sources, including calendars, contacts, other email accounts, etc.

With continuing reference to FIG. 1, the system 100 includes a serving computing device 102 and a number of computing devices 104-108 in communication with the serving computing device 102. The serving computing device 102 and the number of computing devices 104-108 are also in communication with a number of information sources 110 and 112. As described below, information from the information sources 110 and 112 can be provided to one or more of the computing devices 104-108 using features of the serving computing device 102. While a certain number and type of computing devices are depicted in FIG. 1, other embodiments include other arrangements and numbers of such components and FIG. 1 is not intended to be limited to any particular embodiments or examples described herein.

As shown, computing device 108 includes an email web access application 114 for interacting with a remote email source, such as a web server for example. The email web access application 114 enables a user to remotely transmit and receive email messages, but is not so limited. Computing devices 106 and 108 include email applications 116 and 118 which are resident on the respective device 106 and 108, such as the OUTLOOK® email applications. For example, computing devices 104-108 may be desktops, laptops, portable computing devices, or other computing and communication devices. To simplify the foregoing discussion, computing device 104 and email application 116 will be referred to in describing various functionality and applicability of components of the system 100.

As shown in FIG. 1, the serving computing device or server 102 includes an aggregation component 120, a subscription component 122, a rule component 123 including a number of rules 124, and a number of handlers 126. According to one embodiment, the aggregation component 120 and subscription component 122 can be configured as software programs, including executable instructions, to provide various functionality, as described herein. The server 102 also includes storage 128 for storing aggregation and subscription information, but is not so limited. For example, the storage 128 can be used to store profile information associated with a number of users including subscription identifiers to identify user subscriptions associated with particular users.

The subscription component 122 can be used to manage information associated with a number of user subscriptions. In an embodiment, the subscription component 122 can be used to manage a number of web feeds and associated web feed items. Subscription and associated information can be stored in storage 128. The subscription component 122 can also call on or pass information to the aggregation component 120 to aggregate subscription information. As described below, duplicate subscription information can be identified and combined so that a unique set of subscription information can be maintained in storage 128.

The subscription component 122 can also operate to monitor and/or crawl, at various times, all associated user mailboxes when locating and monitoring subscriptions. Once located, the subscription component 122 can continue to monitor the subscriptions and mailboxes to detect any subscription changes and factor any change or changes into an aggregated subscription list to maintain the unique set of subscription information. The unique set of subscription information can be used by the aggregation component 120 when aggregating content associated with the unique set of subscriptions.

The aggregation component 120 can be configured to perform aggregation and other operations. In one embodiment, the aggregation component 120 can be configured to aggregate information associated with a number of subscriptions, such as a number of web feed subscriptions for example, using the unique set of subscription information maintained in storage 128. A subscription provides information so that the aggregation component 120 can identify and retrieve content on some basis, a periodic basis for example. For example, a subscription may identify a URL, username and password, or some other identifying information that the aggregation component 1220 can use to locate and retrieve content associated with a number of web feeds.

The aggregation component 120 can access the subscription and associated information from storage 128 when preparing to retrieve subscription content from the information sources 110 and 112. As shown in FIG. 1, the server 102 also includes a number of handlers 126. The number of handlers 126 can be configured to manage various subscription types. In one embodiment, the number of handlers 126 can be configured to convert downloaded subscription content to an email format or some other desired format. Thereafter, the aggregation component 120 can operate to aggregate the retrieved subscription content.

In one embodiment, the aggregation component 120 includes duplication prevention functionality which can operate to prevent duplicate subscription items from being retrieved from an information source. The aggregation component 120 can be configured to identify similar or duplicate items and then identify whether the associated content is the same or substantially similar when preventing the retrieval of duplicates. In one embodiment, a unique identifier (ID) can be assigned to a subscription item. If two items have the same ID but differing content, the aggregation component 120 treats the differing content as an update to the item based at least in part on the same ID. For example, the aggregation component 120 can operate to calculate a hash to prevent duplicate subscription items from being retrieved from an information source, such as after a crash or restart condition.

The aggregation component 120 can also be configured to aggregate information from other sources, such as additional email accounts, contact repositories, calendars, and other sources. For example, the aggregation component 120 can be configured to aggregate messages from an external mailbox for delivery to an end user's email inbox, wherein various rules can be used to apple a policy to the aggregated messages before delivery. The aggregation component 120 can be further configured to retrieve or download all subscription content, including referred to information and information pointed to by internal links, such that a user can interact with the subscription content while in an offline mode. For example, the aggregation component 120 can retrieve content associated with a hyperlink or information referred to within the context of particular subscription content.

As an example, the aggregation component 120 can retrieve or download various types of information, including multi-level data, associated with a web page which can then be provided to a user via an email account. In one embodiment, the aggregation component 120 can attach information referred or linked to as an email attachment. For example, a media file (audio, video, graphical, image, etc.) can be attached to an email message, wherein an internal link points to the media file in the subscription content. Correspondingly, a user does not have to have an Internet, Intranet, or other network connection in order to interact with subscription content since the aggregation component 120 has collected the associated content and other information.

As shown in FIG. 1, the server 102 also includes a number of handlers 126. The number of handlers 126 can be configured to manage various subscription types. The number of handlers 126 can be configured to download subscription content based in part on a subscription type. In one embodiment, the number of handlers 126 can be configured to convert retrieved or downloaded subscription content and other information to an email format or some other desired format. For example, a handler can be used to convert or map subscription related document text and icons to an email representation based in part on a subscription type.

In one embodiment, one or more handlers can be used to create an abstraction of a subscription to encapsulate any subscription type, wherein each specific subscription type, such as web feed subscription, POP3 account, etc., can be used to extend a base type. Correspondingly, the one or more handlers can use subscription content and other subscription information when mapping to various parts of an email representation. For example, subscription content and other subscription information can be used to map to various email fields, such as: subject, from, recipient, body, and/or other email fields.

Accordingly, the handlers 126 can be used to perform conversion operations on the subscription content to format the subscription content into a desirable format, such as an email format (e.g., Multipurpose Internet Mail Extensions (MIME), etc.) for example. Each handler 126 can be configured to convert from a first format to a second format, corresponding to different types of content and other data structures. For example, the handlers 126 can be configured to map subscription content to fields and other parts of an email message (e.g., author to from, title to subject, published or update date to message date, full-text to body, etc.). Since the system 100 is extensible, other handlers can be added to the system 100 to provide additional handling and conversion functionality.

Once the subscription content has been converted to a desired format, a number of rules 124 can be used to manage the converted subscription content. In an alternative embodiment, one or more of the number of rules 124 can be applied before the conversion operations. For example, the number of rules 124 can be applied to a web feed to implement certain policies when communicating information associated with the web feed through an email pipeline. An enterprise may use or define certain rules according to some desired end result. For example, a corporate compliance policy may be implemented based on certain types of content being brought into the organization, and the number of rules 124 can be used to filter out certain web feeds. As further example, a company may define a rule to journal all inbound messages. Correspondingly, journaling rules can be used to journal email messages that are sent or received by individual users or by various departments within or outside an organization.

Accordingly, by using the server 102 for aggregation and subscription operations, certain policies and other features can be applied to the subscription content before delivering the subscription content to end users. In some cases, an implemented policy, defined by a rule or rule set, may prevent the delivery of subscription content or other content to certain users. In various embodiments, the number of rules 124 can be used to implement routing features, messaging policies, content sanitization features, force forwarding features, recipient copying features, security features, spamming features, antivirus features, anywhere access features, and/or other features and rule functionality.

In an embodiment, a user, such as a system administrator for example, can configure a number of rules 124 to manage and control information traveling through an information pipeline. For example, an application programming interface (API) or other user interface can be used to configure and mange the number of rules 124 to implement a routing or some other enterprise-wide policy. In one embodiment, a user can configure and apply a number of rules including a set of conditions, exceptions, and actions based in part on messages and other information traveling through an email pipeline. Conditions may be used to identify email messages to which a transport rule action or some other action may be applied. Exceptions may be used to identify email messages to which a transport rule action or some other action may not be applied, even if the message matches a condition, such as a transport rule condition for example.

Actions can be applied to email messages that match all or some of the conditions and none of the exceptions. The actions can be configured to modify some aspect of a message, the delivery of a message, and/or some other messaging feature. For example, the rules 124 can be applied to identify certain terms in email messages traveling through an email pipeline. If a certain term is identified, an associated action may be taken, such as a non-delivery action for example. The rules 124 can also be used to identify which subscription may be delivered to which user. For example, finance related rules can be used to make sure relevant financial information is delivered to a finance team.

The various computing devices and information sources can communicate with each other and other communication devices. For example, the various devices and sources can communicate over a communication network, such as the Internet. Moreover, the various components of FIG. 1 can communicate using more than one network or other communication environments, including wired, wireless, combinations of wired and wireless, local, remote, local and remote, and/or other communication infrastructures.

The system 100 includes networking, security, and/or other communication functionality to provide a secure and robust communication environment. For example, the system 100 can be implemented as part of networked, distributed, or other computing environment. A number of client computing devices, including desktop computers, laptops, handhelds, and/or other smart devices can interact with and/or be included as part of the system 100. The system 100 can also include multiple clients and is not limited to any particular configuration, wherein each client can include various functionality and other components.

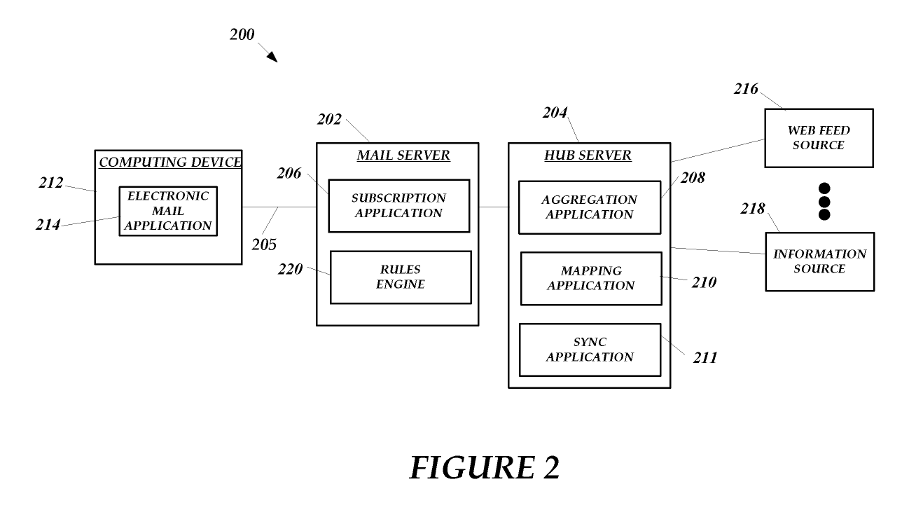

FIG. 2 is a block diagram of a system 200 that can be configured to provide information to a user or users of the system 200, in accordance with an embodiment. In one embodiment, the system 200 can be configured to deliver subscription content and other information by using an email representation and mapping functionality. Components of the system 200 can use information, including information associated with a number of subscriptions, to manage and control the delivery of subscription content and other information. As described below, the system 200 provides a content syndication framework including load balancing and failover features, duplication prevention features, error propagation features, ready to publish features, and other features and functionality.

As shown in FIG. 2, the system 200 includes a mail server 202 and a hub server 204. In one embodiment, the mail server 202 and hub server 204 can be configured as an email and communication infrastructure and framework. The email communication infrastructure and framework includes various applications and associated functionality and can be used to monitor and control a delivery of subscriber content to subscribers using an email pipeline 205, but is not so limited. For example, the mail server 202 and hub server 204 can be configured to provide a content syndication framework using the functionality of an EXCHANGE® and EXCHANGE SERVER® email and communication infrastructure.

The following description describes how components of the system 200 can be used to control a delivers, of subscription content and other information, but the system 200 is not so limited. For example, an administrator may interact with the mail server 202 and hub server 204 to configure and use various rules when controlling subscription deliveries and subscription access. As further example, a user may configure a number of rules to control delivery times, delivery types, recipients, automatic forwarding, automatic journaling, etc. One or more of the number of rules may be configured based in part on the identity of a subscriber or subscribers and according to other factors, such as a company-wide subscription and distribution policy for example. Correspondingly, components of the system 200 can be used to determine if, when, and/or how subscription content and other information is to be delivered through the email pipeline 205.

If subscription content is to be delivered, a mapping application 210 can be used to package subscription content, including aggregated subscription content, which can then be delivered to user inboxes or other locations using the email and communication infrastructure. In one embodiment, the system 200 can operate to aggregate information associated with a number of user subscriptions and apply certain rules to subscription information being communicated through the email pipeline 205 to user inboxes. After applying any rules, the subscription information may or may not be delivered to a user's email inbox. In some cases, subscription information may be diverted, rerouted, saved, and/or not delivered. Other operations can be implemented by configuring various rules or adding new rules to control delivery and other information communications.

In one embodiment, upon delivery, a user can use a web application, an email application, or other interactive application to interact with the delivered subscription information. As part of the interaction, a user can monitor and control feed and other subscriber information. For example, a user can use an email application to read a subscription, reply to a subscription feed, forward/copy a subscription, etc. The user can also change aspects of a feed or feeds, such as feeds to include and feeds to exclude for example. Moreover, any aggregation errors on the server side can be propagated to an end user not only in a form of last error that can be displayed by a client, but also as part of a system message delivered to the user's mailbox, explaining any error and possible corrective actions.

In one embodiment, components of the system 200 can be used to deliver subscription content to an email application, such that the subscription content arrives in a user's inbox represented or packaged as part of an email format. In an embodiment, the mapping application 210 can be used to convert subscription content to an email format. That is, the mapping application 210 can be configured to convert or map the subscription content and associated information to an email data structure, thereby allowing the delivered subscription content to be rendered as an email. Information associated with the subscription content and/or feed can be used when mapping to an email representation.

In one embodiment, the mapping application 210 can be used to create an abstraction of a subscription to encapsulate any subscription type, wherein each specific subscription type, such as web feed subscription, POP3 account, etc. can be used to extend a base type. Correspondingly, the mapping application 210 can use subscription content and other subscription information when mapping to various parts of an email representation. For example, subscription content and other subscription information can be used to map to various email fields, such as: subject, from, recipient, body, and/or other email fields.

For example, the Table below illustrates a mapping that may be used by the mapping application 210 involving feed item properties and generated message properties. In an embodiment, the information of the Table below can be used as part of an abstraction process to create or form a normalized feed object which can be delivered to a user inbox.

TABLE

| Feed Item Property | Message Property |
|---|---|
| Authors | From: MIME header |
| Categories | None |
| Content | Attachments |
| Contributors | None |
| Copyright | None |
| Id | Message-ID: MIME header |
| LastUpdatedTime | Date: MIME header |
| Links | Attachments |
| PublishDate | Date: MIME header if LastUpdatedTime is absent |
| SourceFeed | None |
| Summary | Message body |
| Title | Subject: MIME header |

With continuing reference to FIG. 2, the hub server 204 also includes a sync application 211. In an embodiment, the sync application 211 can be configured to provide two-way content syndication. As part of a two-way, content syndication process, the sync application 211 can operate to provide a two-way replication or content. For example, the sync application 211 can be used for message syndication, wherein changes (create, delete, update of message and/or state) made at either end can be replicated to the other end.

A computing device 212 is in communication with the mail server 202. The computing device 212 can also be in communication with the hub server 204 and one or more information sources. The computing device 212 also includes an email application 214. In one embodiment, the email application 214 can be implemented as a web-based application and the computing device 212 corresponds to a portable computing device, such as a PDA for example. While one such computing device 212 is shown in FIG. 2, any number of computing devices can be included with the system 200, and each computing device is not limited to any particular type (e.g., laptop, tablet, desktop, etc.). Additionally, the system 200 can include additional components, including additional and redundant hub servers and email servers, according to a desired implementation and functionality.

As described briefly above, as part of a subscription process, the mail server 202 and hub server 204 can be configured to monitor, manage, and control the delivery of subscription content to subscribers. In one embodiment, the mail server 202 can be configured to aggregate and dispatch subscription information to a selected hub server. The selected hub server can be configured for syndicated content aggregation, email conversion, and submission operations, but is not so limited. The hub server 204 can also be used to retrieve, download, or otherwise access subscription content using a number of information sources. As described below, the hub server 204 also includes an aggregation application 208 that can be used for aggregation and other processes.

As shown in FIG. 2, subscription content can retrieved or otherwise accessed from a web feed source 216 and another information source 218, such as a SHAREPOINT® serving system for example. However, other information sources are available for interaction and retrieval purposes. Once retrieved, subscription content and other information can be delivered to users. In an embodiment, the mail server 202 can be used to communicate syndicated items and associated information using message pipeline 205, such as the email pipeline for example.

The mail server 202 includes a subscription application 206 which includes functionality to manage and control subscription information associated with a number of subscriptions and users. The subscription application 206 can be used when retrieving various subscription information as part of the managing and controlling of subscription content delivery, to subscribers, but is not so limited. As part of a subscription retrieval process, the subscription application 206 may be used to dispatch subscriptions of all types to the hub server 204 for aggregation and other operations. The mail server 202 also includes a rules engine 220, wherein a number of rules can be implemented to control a delivery of subscription content. The rules engine 220 can be used to apply routing procedures, messaging policies, sanitization, security, and other features. In an alternative embodiment, the hub server 104 can also include a rules engine to handle inbox, transport, and other rules.

As described above, more than one hub server 204 can be included in the system 200. In another embodiment, as part of the content aggregation process, the aggregation application 208 can be configured to map from a first format associated with a subscription type to a second format, such as an email representation for example. For example, the aggregation application 208 can use a dispatch table to map from a specific subscription type to a protocol handler, wherein the protocol handler can then be used to download content and convert to a message or email representation.

The subscription application 206 can store user subscriptions in an email store or other storage. Other clients can be used to provide a subscription management facility. For example, a web-based application can be used to manage various user subscriptions. In an embodiment, the subscription application 206 can be configured with duplication prevention functionality. Accordingly, the subscription application 206 can be used to prevent or limit duplicate subscription content from being retrieved, thereby reducing an amount of bandwidth and time when retrieving subscription content. In one embodiment, the subscription application 206 can be used to detect duplicated messages based in part on a client submit time and/or a message ID. The subscription application 206 can be used to generate a deterministic timestamp and an ID string for each syndicated item. Thereafter, the deterministic timestamp and ID string can be mapped to a client submit time and message ID on the corresponding email message.

Load balancing processes can be used to balance loads being managed by components of the system 200. For example, load balancing operations can be used to manage subscription loads being handled by the mail server 202 and the hub server 204. In one embodiment, load balancing operations include load balancing of subscription retrieval and load balancing of content aggregation. As part of the load balancing, subscription retrieval operations can be spread or distributed among mail servers associated with user email stores based in part on a shared state determination.

For subscriptions that do not have a shared state, like POP for example, the subscription information may be dispatched to all available hub servers for processing. For subscriptions that include a shared state, a web resource state of a web feed for example, the subscription information may be dispatched to one or more hub servers based in part on a hash of a key which a state keyed off of. For example, a uniform resource identifier (URI) includes a state that may be shared by all subscriptions that use it. The dispatching may be based on a hash of the URI to determine which hub server to send to. The affinity allows the state to be reused to increase efficiency. In case a hub server is not available (busy, down, etc.), a distribution algorithm may be used to redistribute the subscriptions to other hub servers while minimizing the affinity change.

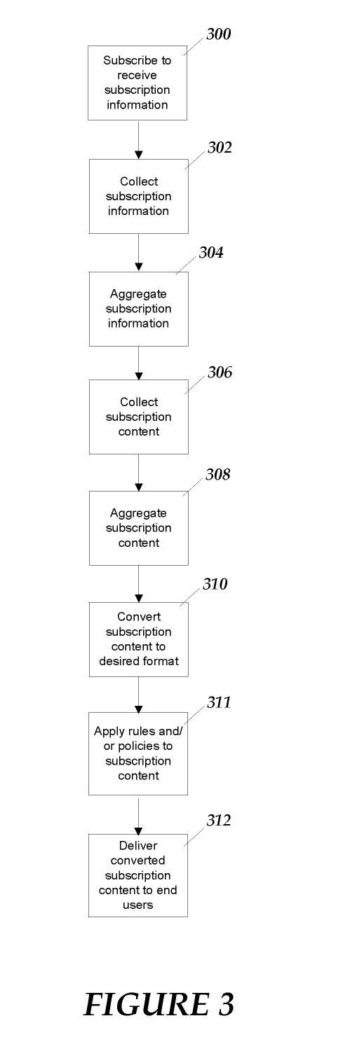

FIG. 3 is a flow diagram illustrating a process for providing information to users, under an embodiment. The components of FIG. 1 are used in the description of FIG. 3, but the embodiment is not intended to be so limited. At 300, a user can subscribe to receive information from one or more information sources 110 and 112. For example, a user can use a web-based application to subscribe to receive sports-related subscription content from a number of sport syndications.

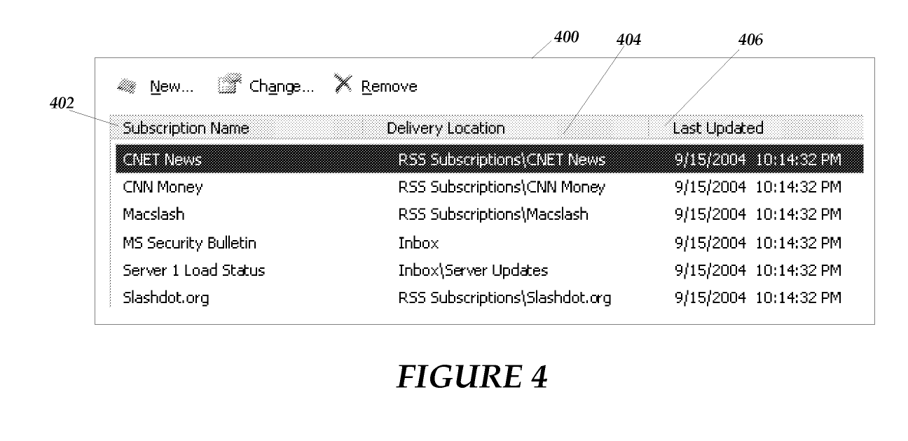

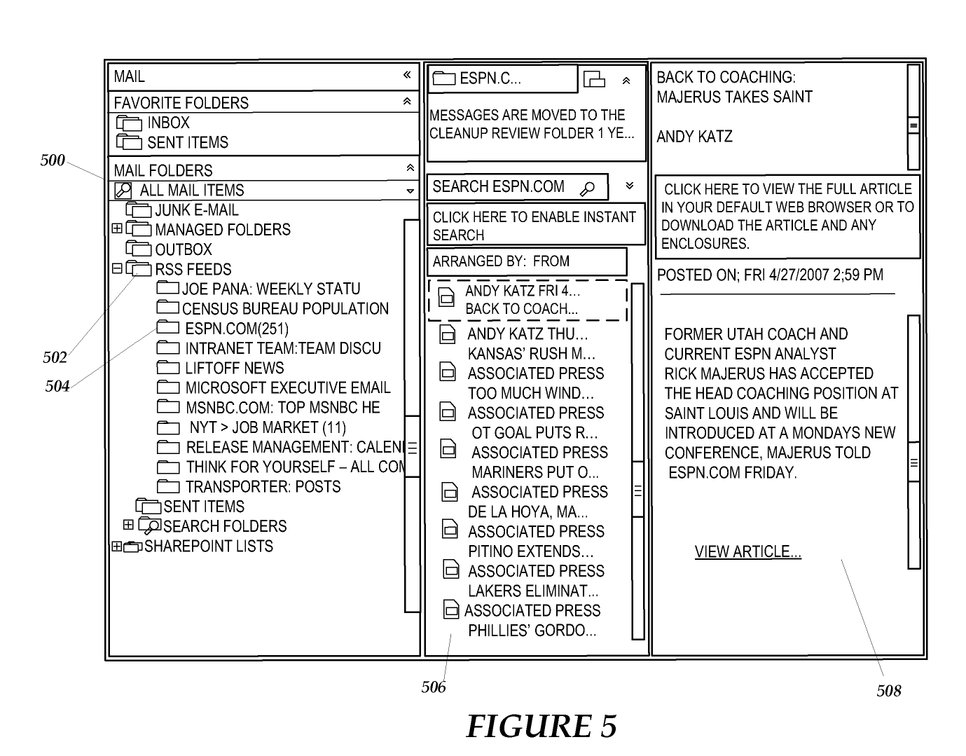

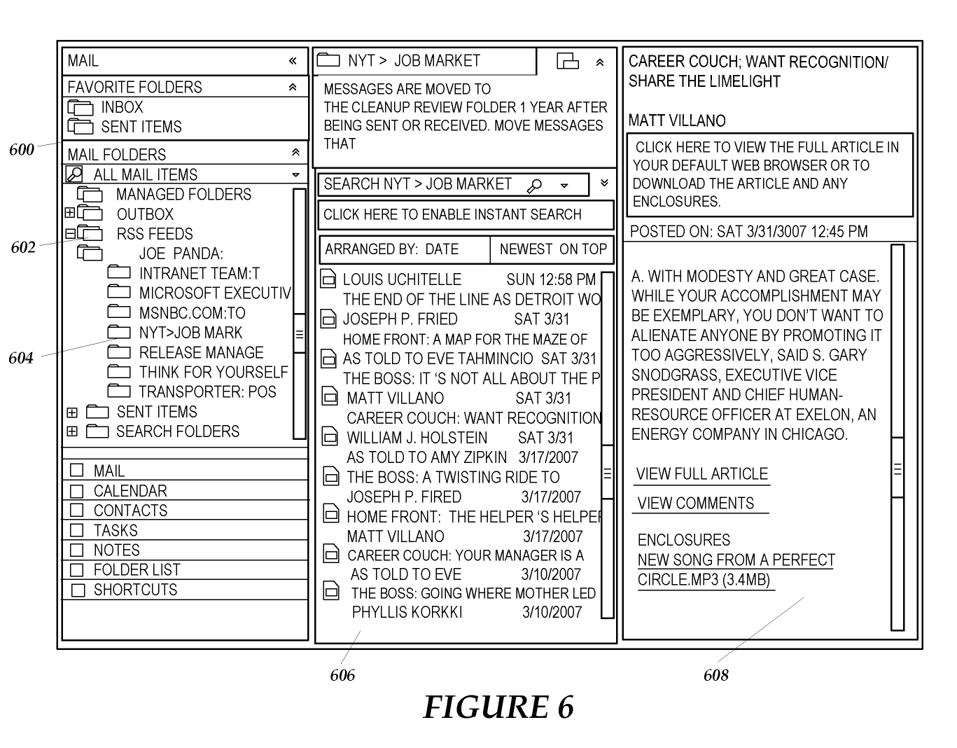

At 300, multiple users can subscribe to receive subscription content from a plurality of information sources. For example a user can add a subscription to be received by an email client by using a subscription manager UI to add new feeds (see FIG. 4). The user can cut and paste or type a URL for each feed into the UI when subscribing to receive subscription content, such as RSS, Atom, and other content types for example. A folder can be included under a root folder, such as an RSS root folder for example (see FIGS. 5-6), in a select email application, including web-based email applications. The folders can include and highlight unread items so users can recognize when new content is available.

At 302, the subscription component 102 operates to collect subscription information associated with a number of user subscriptions. For example, the subscription component 102 can collect subscription information from a number of enterprise users at periodic intervals. In another embodiment, users can submit subscription information to the subscription component 102. As part of the collection process, the subscription component 102 can operate to locate and discard duplicate subscription information. For example, two users may be subscribing to the same feed and the subscription component 102 can discard the duplicate while continuing to associate the intended recipients with the subscription content.

At 304, the aggregation component 120 operates to aggregate the collected subscription information. At 306, using the aggregated subscription information, the aggregation component 120 operates to collect subscription content associated with the aggregated subscription information. As part of the collection process, the aggregation component 120 can operate to interact with multiple information sources, such as a number of web feeds for example, to retrieve the subscription content. For example, the aggregation component 120 can use a number of URLs to locate various web feeds to retrieve desired content. The aggregation component 120 can also operate to retrieve other information, such as other emails from alternative email accounts, contact information, and/or calendar information for example.

At 308, the aggregation component 120 operates to aggregate the subscription content and any other retrieved information in preparing to deliver the aggregated subscription content and other information to subscribers. At 310, the aggregation component 120 uses one or more handlers 126 to convert the subscription content and other information into an email representation in preparation to deliver the subscription content and other information to a subscriber inbox.

At 311, the aggregation component 120 can apply a number of rules 124 to subscription content to be delivered to subscribers. At 312, the aggregation component 120 delivers the converted subscription content and other information to subscriber inboxes as email representations. Thereafter, a subscriber can interact with the delivered subscription content and other information using an email application including web-based email applications. In another embodiment, the subscription content and other information can be delivered as part of an instant messaging or other messaging protocol.

FIG. 4 depicts a user interface 400 that is configured to enable a user to subscribe to various information sources, in accordance with an embodiment. As shown in FIG. 4, the user interface 400 includes a subscription name field 402 which can be used to designate a name for a particular subscription. A number of subscription types are depicted in the subscription name field 402. The user interface 400 also includes a delivery location 404 that can be used to designate a location for locating subscription content. A number of designated locations are depicted for disseminating subscription content. A user can tailor the deliver location 404 for a desired location or locations to receive subscription content. The user interface 400 also includes a last update field 406 to provide information to a user regarding when subscription content was last updated.

FIG. 5 depicts an example user email application 500. As shown in FIG. 5, the user inbox includes an RSS Feeds folder 502 that include a number of RSS feeds. The user has highlighted the ESPN.com feed 504 listing a number of subscription items in another pane 506. The user has further highlighted a particular item which operates to depict item details, such as the full article text for example, in another pane 508.

FIG. 6 depicts an example user email application 600. As shown in FIG. 6, the user inbox includes an RSS Feeds folder 602 that include a number of RSS feeds. The user has highlighted the NYY>Job Market feed 604 listing a number of subscription items in another pane 606. The user has further highlighted a particular item which operates to depict item details, such as the full article text for example, in another pane 608.

As described in detail above, one or more server-side components can be configured to aggregate and deliver subscription content and other information to an email application. The various embodiments can be configured to aggregate subscription information and content as part of an efficient delivery of subscription content and other information to end users. Rules, including email pipeline rules, can be used to control a delivery of subscription and other content by controlling if, how, and when subscription content is to be delivered to end users. Other embodiments and configurations are available.

### Exemplary Operating Environment

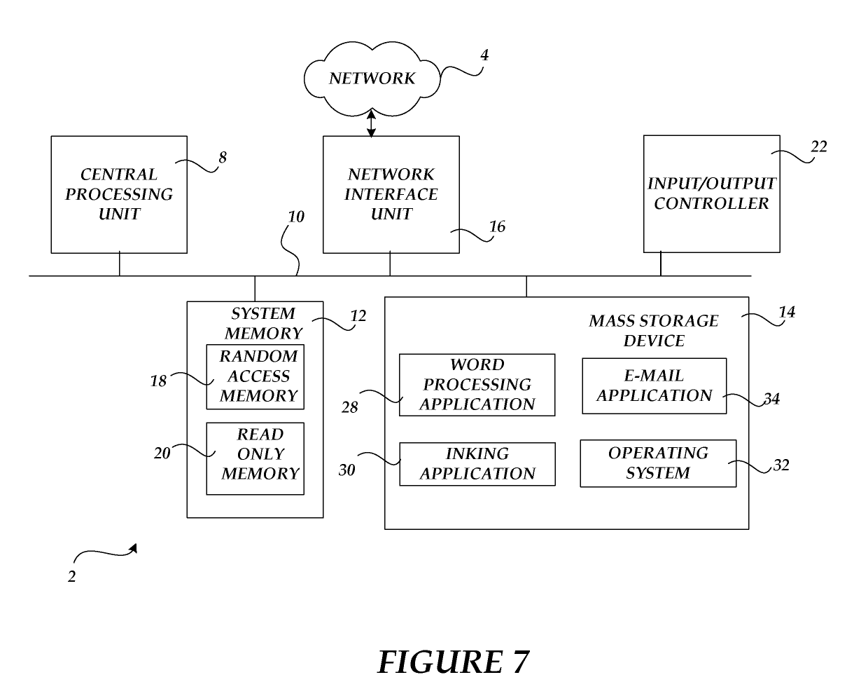

Referring now to FIG. 7, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 7, an illustrative operating environment for embodiments of the invention will be described. As shown in FIG. 7, computer 2 comprises a general purpose desktop, laptop, handheld, tablet, or other type of computer capable of executing one or more application programs. The computer 2 includes at least one central processing unit 8 (“CPU”), a system memory 12, including a random access memory 18 (“RAM”) and a read-only memos (“ROM”) 20, and a system bus 10 that couples the memory to the CPU 8. A basic input/output system containing the basic routines that help to transfer information between elements within the computer, such as during startup, is stored in the ROM 20.

The computer 2 further includes a mass storage device 14 for storing an operating system 32, application programs and other program modules. The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of input types, including a keyboard, mouse, pen, stylus, finger, and/or other means. Similarly, an input/output controller 22 may provide output to a display, a printer, or other type of output device. Additionally, a touch screen can serve as an input and an output mechanism.

As mentioned briefly above, a number of program modules and data files may be stored in the mass storage device 14 and RAM 18 of the computer 2, including an operating system 32 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as a word processing application 28, an inking application 30, e-mail application 34, drawing application, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art still understand that many modifications can be made thereto within the scope of the claims that follow. Accordingly, it is not intended that the scope of the invention in any way be limited by the above description, but instead be determined entirely by reference to the claims that follow.

What is claimed is:

1. A system configured to manage a provisioning of information, the system comprising:
a server comprising:
a subscription component configured to use subscription information associated with a number of subscriptions;
an aggregation component configured to aggregate the number of subscriptions, wherein the aggregation component is configured to retrieve subscription content associated with the number of subscriptions and further includes a number of handlers configured to manage a number of subscription types, wherein each handler can be configured to map from a subscription format to a message representation; and,
a store to store the number of subscriptions and subscription information.

2. The system of claim 1, wherein each handler is further configured to map from the subscription format to all email representation by mapping subscription items to parts of the email representation.

3. The system of claim 1, further comprising an email server and a hub server, wherein the email server and hub server are configured to manage and control the deliver of the web feed items based in part on a number of defined delivery rules to manage the delivery of the web feed items.

4. The system of claim 1, further comprising a rule component including a number of rules that can be configured to apply a messaging policy when controlling a delivery of the subscription content.

5. The system of claim 1, further comprising an email communication pipeline, wherein the system further includes a number of rules which can be configured to control a delivery of subscription content communicated through the email communication pipeline.

6. The system of claim 4, wherein one or more of the number of rules can be configured to apply a messaging policy when controlling the deliver; of the subscription content.

7. The system of claim 5, wherein the number of rules can be configured to filter feed items by directing specific feed items to designated user inboxes.

8. The system of claim 5, wherein the number of rules include a set of associated conditions, exceptions, and actions.

9. The system of claim 8, wherein the set of conditions identify messages to which an action can be applied, exceptions identify the messages to which an action should not be applied, and an action can be used to affect the deliver, of the messages.

10. The system of claim 1, wherein the aggregation component is further configured to aggregate and deliver email items from alternative email stores, calendar information, and contact information to an email inbox.

11. The system of claim 1, wherein the aggregation component is further configured to deliver syndicated content to a number of email inboxes.

12. The system of claim 1, wherein the subscription component is further configured to remove duplicate subscription information to maintain a unique set of subscription information.

13. The system of claim 1, wherein the subscription component is further configured to monitor user mailboxes when locating subscriptions and monitoring subscription changes such that the aggregation component can use a unique set of subscription information when aggregating subscription items.

14. The system of claim 1, wherein the aggregation component can operate to retrieve linked subscription content associated with the subscriptions, thereby enabling a user to interact with the linked subscription content while in an offline mode.

15. A system configured to manage a delivery, of information comprising:
first serving component for collecting information associated with a number of web feed items, wherein the first serving component includes a number or rules that can be configured to control the delivery of the web feed items based at least in part on a number of conditions, exceptions, and actions; and,
second serving component for aggregating the number of web feed items and retrieving content associated with the number of web feed items, wherein the second serving component is further configured to convert from a web feed format to an email representation.

16. The system of claim 15, further comprising an email server for retrieving subscription information associated with the number of web feed items and a hub server for aggregating and converting the subscription information and the number of web feed items, wherein the email server and hub server are configured to manage and control the delivery of the web feed items based in part on the number of rules, wherein the number of rules can be configured to control the delivery of the web feed items to one or more email inboxes.

17. A method of managing a communication of information comprising:
retrieving information associated with a number of user subscriptions, wherein the number of user subscriptions is associated with subscription content;
collecting the information associated with the number of subscriptions including the subscription content;
converting the subscription content to a message representation; and,
controlling a deliver of the subscription content using one or more messaging rules, wherein the one or more messaging rules can be used to distribute the subscription content to a user in accordance with the message representation.

18. The method of claim 17, further comprising removing duplicate information associated with the number of user subscriptions, including duplicate web feed items.

19. The method of claim 17, further comprising balancing a subscription load based at least in part on a shared state determination.

20. The method of claim 17, further comprising retrieving linked content associated with the subscription content to enable interaction with the linked content while in an offline mode.
